(19) United States
(12) Patent Application Publication
(10) Pub. No.: US 2026/0278261 A1
(43) Pub. Date: Sep. 17, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Nozomi TABATA, Tokyo (JP); Shinji CHICHIBU, Tokyo (JP)

(73) Assignee: NEC Corporation, Tokyo (JP)

(21) Appl. No.: 19/464,970

(22) Filed: Jan. 30, 2026

(30) Foreign Application Priority Data
Mar. 17, 2025 (JP) 2025-042484

(51) Int. Cl. G06F 40/186

(52) U.S. Cl. CPC G06F 40/186

(57) ABSTRACT

In order to visualize a process in which a result is generated by generative AI and a basis for the result to improve the transparency and reliability of operation of the generative AI, in an information processing device, a processor acquires input information from a user. The processor performs processing based on the input information to generate a result. The processor records process information used in a process of generating the result. The processor displays the result and basis information indicating a basis for the result based on the process information, simultaneously. The processor receives editing on the basis information from the user. This arrangement enables reliable AI-driven decision making by allowing users to visualize, edit, and verify the reasoning process behind generated results.

### INCORPORATION BY REFERENCE

This application is based upon and claims the benefit of priority from Japanese Patent Application 2025-042484, filed on Mar. 17, 2025, the disclosure of which is incorporated herein in its entirety by reference.

### TECHNICAL FIELD

The present disclosure relates to a technique for presenting a process of generating a result and a basis for the result.

### BACKGROUND ART

In recent years, a system that generates a result that a user desires by using a plurality of types of generative artificial intelligence (AI) has been introduced. Due to the development of such a system, an environment capable of flexibly meeting users’ various demands is been being established. A generative AI tool has a black-box-like property and thus its internal process and determination rule are opaque, but the visualization thereof is currently known. JP 2024-168955 A describes a technique for presenting useful data for a user to recognize a basis for a prediction made by generative AI.

Patent Document 1: Japanese Patent Application Laid-Open under No. 2024-168955

### SUMMARY

However, even in a case where a conventional generative AI tool has its internal process and determination rule visualized, as a disadvantage, a user can only perform updating through repeated dialogues because the user does not know what the problem is. A user who is inexperienced in a specialized field does not know what questions to ask in a dialogue manner and thus, in general, users are required to actively use such a generative AI tool.

An object of the present disclosure is to provide an information processing device that visualizes a process in which a result is generated by generative AI and a basis for the result to improve the transparency and reliability of operation of the generative AI.

According to an example aspect of the present invention, there is provided an information processing device including:

at least one memory configured to store instructions; and

at least one processor configured to execute the instructions to:

acquire input information from a user;

perform processing based on the input information to generate a result;

record process information used in a process of generating the result;

display the result and basis information indicating a basis for the result based on the process information, simultaneously; and

receive editing on the basis information from the user.

According to another example aspect of the present invention, there is provided an information processing method to be performed by an information processing device, the information processing method including:

acquiring input information from a user;

performing processing based on the input information to generate a result;

recording process information used in a process of generating the result;

displaying the result and basis information indicating a basis for the result based on the process information, simultaneously; and

receiving editing on the basis information from the user.

According to still another example aspect of the present invention, there is provided a non-transitory computer-readable recording medium storing a program to be executed by an information processing device including a computer, the program causing the computer to perform processing including:

acquiring input information from a user;

performing processing based on the input information to generate a result;

recording process information used in a process of generating the result;

displaying the result and basis information indicating a basis for the result based on the process information, simultaneously; and

receiving editing on the basis information from the user.

### EFFECT

According to the present disclosure, provided can be an information processing device that visualizes a process in which a result is generated by generative AI and a basis for the result to improve the transparency and reliability of operation of the generative AI.

### BRIEF DESCRIPTION OF THE DRAWINGS

FIG. 1 illustrates an exemplary schematic configuration of a result generation system according to the present disclosure;

FIGS. 2A and 2B are block diagrams illustrating exemplary hardware configurations of a server and a user terminal;

FIG. 3 is a block diagram illustrating an exemplary functional configuration of the server;

FIGS. 4A and 4B illustrate exemplary project support screens;

FIG. 5 illustrates an exemplary data configuration of a template DB;

FIG. 6 is a flowchart illustrating exemplary result generation processing that the server performs;

FIG. 7 is a block diagram illustrating a functional configuration of an information processing device; and

FIG. 8 is a flowchart illustrating exemplary processing that the information processing device performs.

### EXAMPLE EMBODIMENTS

Example embodiments of the present disclosure will be described below with reference to the drawings.

### First Example Embodiment

### Entire Configuration

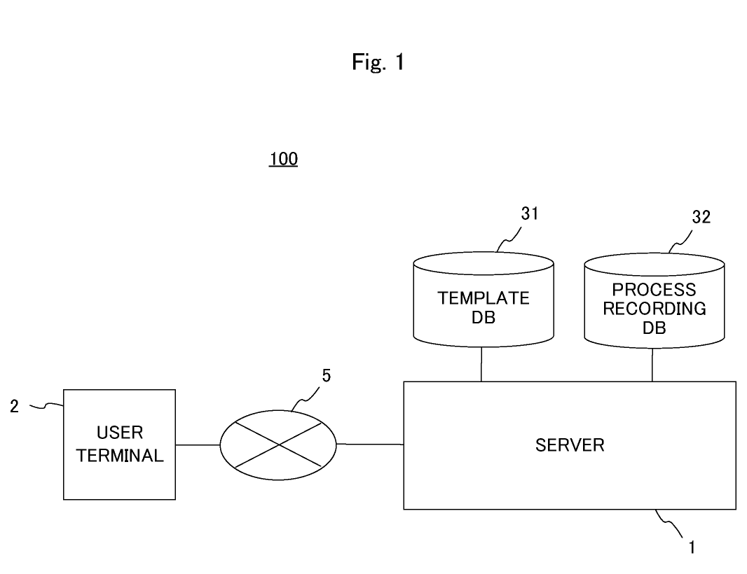

FIG. 1 illustrates an exemplary schematic configuration of a result generation system 100 to which an information processing device according to the present disclosure is applied. The result generation system 100 corresponds to a system that visualizes a process in which a result is generated by generative AI and a basis for the result to allow a user to perform editing, leading to improvements in the transparency and reliability of operation of the generative AI.

In the result generation system 100 in FIG. 1, a server 1 and a user terminal 2 are communicably connected through a network 5, such as the Internet. The user corresponds to a person who requests generation of a result using the generative AI.

The server 1 corresponds to an information processing device that performs processing on various types of data using the generative AI, storage, and transmission/reception, and receives input information from the user terminal 2 or transmits, to the user terminal 2, a generated result and information regarding a process and a basis for the generated result. The server 1 is connected to a template DB 31 and a process recording DB 32, which will be described later. Note that the server 1 may be a virtual server in a cloud environment. The server 1 is an exemplary information processing device according to the present disclosure.

The user terminal 2 is, for example, a smartphone, a tablet, or a PC that the user uses, and transmits, to the server 1, input information for requesting generation of a predetermined result or receives, from the server 1, a result and information regarding a process and a basis for the result.

### Hardware Configuration

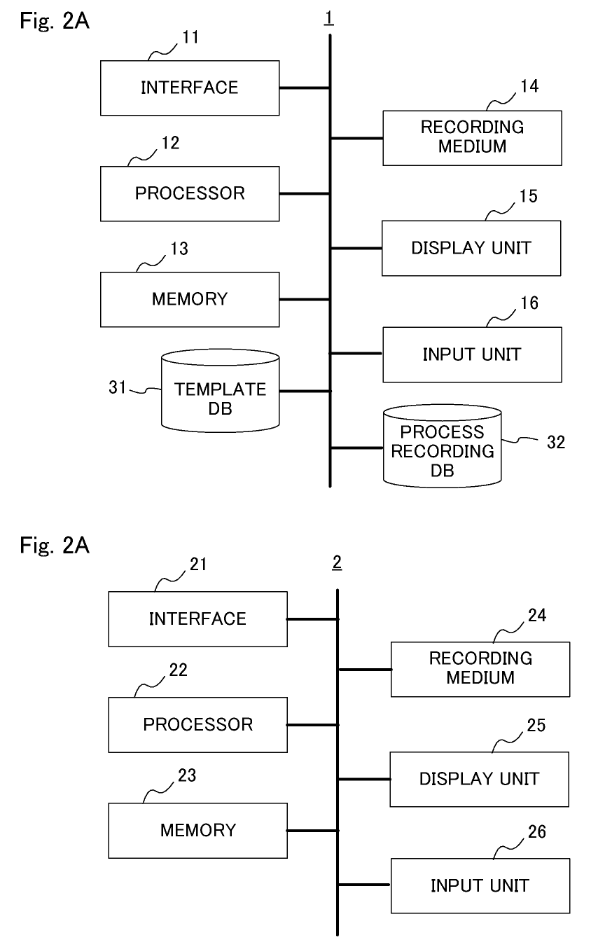

FIG. 2A is a block diagram illustrating an exemplary hardware configuration of the server 1. As illustrated, the server 1 includes an interface 11, a processor 12, a memory 13, a recording medium 14, a display unit 15, and an input unit 16. Note that such constituent elements, the template DB 31, and the process recording DB 32 are mutually connected through a bus.

The interface 11 performs data exchange with the user terminal 2. The interface 11 is used in order to receive input information from the user terminal 2 or to transmit, to the user terminal 2, a generated result and information regarding a process and a basis for the generated result.

The processor 12 corresponds to a computer, such as a central processing unit (CPU), and executes a program prepared in advance to control the entire server 1. Note that, as the processor 12, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or any combination thereof can be used.

The memory 13 includes, for example, a read only memory (ROM) and a random access memory (RAM). The memory 13 stores a program that the processor 12 executes. In addition, the memory 13 is used as a work memory while the processor 12 is performing various types of processing.

The recording medium 14 corresponds to a non-volatile and non-transitory recording medium, such as a disk-shaped recording medium or a semiconductor memory, and is detachably attached to the server 1. The recording medium 14 has various types of programs, which the processor 12 executes, recorded thereon. In order for the server 1 to perform result generation processing, which will be described later, a program recorded on the recording medium 14 is loaded into the memory 13 and the processor 12 executes the program.

The display unit 15 is, for example, a liquid crystal display (LCD) and displays various types of images while the server 1 is operating. The input unit 16 is, for example, a keyboard, a mouse, or a touch panel, and is used by an operator who manages the server 1.

The template DB 31 records a template including a prompt used in processing for generating a result using the generative AI. The prompt includes a plurality of parameters, and the template DB 31 records the prompt in association with the plurality of parameters, which will be described in detail later.

The process recording DB 32 records process information used in a process of generating a result. Specifically, the process information corresponds to information indicating a process of inferring a result, and examples of the process information include a prompt used in processing for generating a result, a data source or reference information used at the time of generation of a result, learning data for an AI model, and an evaluation of a generated result. The data source or the reference information may be a link indicating information used at the time of generating a result or the information itself. The evaluation of a generated result includes information regarding regeneration of a result by a reprocessing unit 49, which will be described in detail later.

FIG. 2B is a block diagram illustrating an exemplary hardware configuration of the user terminal 2. As illustrated, the user terminal 2 includes an interface 21, a processor 22, a memory 23, a recording medium 24, a display unit 25, and an input unit 26.

The interface 21 performs data exchange with the server 1 through the network 5. The interface 21 is used in order to transmit, to the server 1, input information from the user or to receive, from the server 1, a result and information regarding a process and a basis for the result.

The processor 22 corresponds to a computer, such as a CPU, and executes a program prepared in advance to control the entire user terminal 2. Note that, as the processor 22, a CPU, a GPU, a DSP, an MPU, an FPU, a PPU, a TPU, a quantum processor, a microcontroller, or any combination thereof can be used.

The memory 23 includes, for example, a ROM and a RAM. The memory 23 stores a program that the processor 22 executes. In addition, the memory 23 is used as a work memory while the processor 22 is performing various types of processing.

The recording medium 24 corresponds to a non-volatile and non-transitory recording medium, such as a disk-shaped recording medium or a semiconductor memory, and is detachably attached to the user terminal 2. The recording medium 24 has various types of programs, which the processor 22 executes, recorded thereon. The display unit 25 is, for example, an LCD and displays various types of images while the user is operating the user terminal 2. The input unit 26 is, for example, a touch panel and is used by the user to perform a predetermined operation.

### Functional Configuration

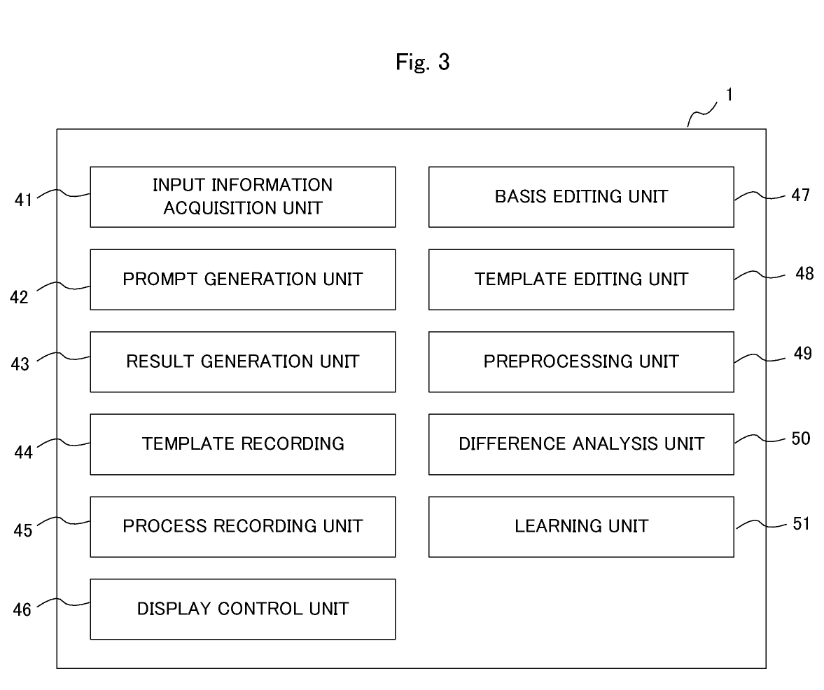

FIG. 3 is a block diagram illustrating an exemplary functional configuration of the server 1. The server 1 functionally includes an input information acquisition unit 41, a prompt generation unit 42, a result generation unit 43, a template recording unit 44, a process recording unit 45, a display control unit 46, a basis editing unit 47, a template editing unit 48, a reprocessing unit 49, a difference analysis unit 50, and a learning unit 51.

The processor 12 executes a program to achieve the input information acquisition unit 41, the prompt generation unit 42, the result generation unit 43, the template recording unit 44, the process recording unit 45, the display control unit 46, the basis editing unit 47, the template editing unit 48, the reprocessing unit 49, the difference analysis unit 50, and the learning unit 51.

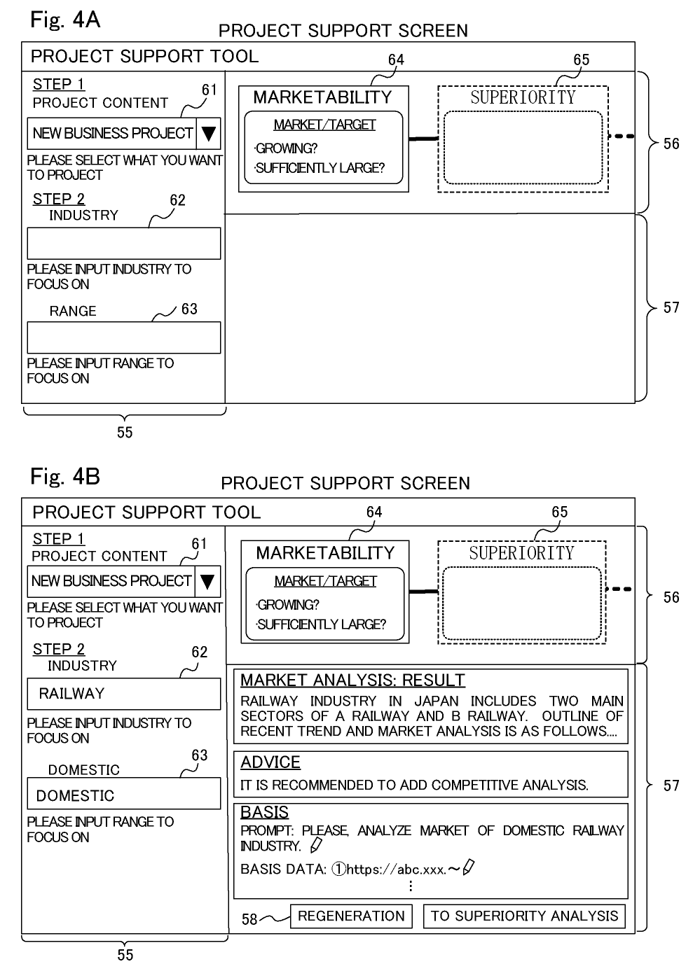

The input information acquisition unit 41 acquires, from the user terminal 2, input information input by the user who requests a result. The input information corresponds to information necessary for generating a result, and the user inputs the input information through a predetermined screen displayed on the user terminal 2. FIG. 4A illustrates an exemplary project support screen. The project support screen corresponds to a screen displayed on a project support tool and includes an input area 55, an analysis target area 56, and a result display area 57. The server 1 transmits information regarding the project support screen to the user terminal 2 to display the project support screen.

The input area 55 corresponds to an area to which the user inputs input information and includes a project content item 61 in which a project content is selected and parameter items 62 and 63 to which inputs are made in accordance with the selected project content. The analysis target area 56 corresponds to an area for displaying an analysis target to be analyzed along a previously determined scenario in accordance with the project content selected by the user. The result display area 57 corresponds to an area for displaying, for example, a result generated in accordance with the input information, advice, and a basis for the generated result.

For example, as illustrated in FIG. 4B, when the user selects “new business project” in the project content item 61, a market analysis item 64 and a superiority analysis item 65 are displayed in the analysis target area 56 along the previously determined scenario for “new business project”. In this case, the market analysis item 64 that is a target for which an analysis result is generated is active, and the superiority analysis item 65 that is not a target for which an analysis result is generated is inactive.

As above, the project support tool corresponds to a tool that provides specific advice or input guidance, an analysis result, and a basis for the analysis result using the generative AI due to input along the scenario for the project content selected by the user. Thus, a beginner can use the tool without any hesitation and an advanced-level person can carry out thorough investigation and elaboration using the tool.

Next, in a case where the market analysis item 64 is active, as illustrated in FIG. 4B, the user inputs “railway” to the parameter item 62 for input of an industry to focus on at the time of analysis of marketability. In addition, the user inputs “domestic” to the parameter item 63 for input of a range to focus on for analysis of marketability. As above, since the user inputs an industry and a range, the user him/herself can edit parameters with high flexibility.

In response to completion of selection in the project content item 61 and input to the parameter items 62 and 63 in the input area 55 by the user, the user terminal 2 transmits, to the server 1, as input information, the marketability as the analysis target and information on the industry “railway” and the range “domestic” to be analyzed. Thus, the input information acquisition unit 41 acquires the input information from the user terminal 2.

Note that the project support screen is an example through which the server 1 acquires the input information and thus the theme or layout of the screen can be freely set. A method using which the server 1 acquires the input information is not limited to this, and thus a freely selected method, such as a chat manner, can be set.

The prompt generation unit 42 generates a prompt for use in processing for generating a result, based on the input information. For example, in a case where the input information includes the marketability as the analysis target and information on the industry “railway” and the range “domestic” to be analyzed, the prompt generation unit 42 generates the prompt “Please, analyze the market of the domestic railway industry”. As above, such a prompt includes a plurality of parameters, such as an industry and a range. Note that the prompt generation unit 42 may generate a prompt using a template recorded by the template recording unit 44, which will be described later.

The result generation unit 43 performs processing for inputting, to the generative AI, the prompt generated based on the input information to generate and acquire a result that the user requests. For example, the result generation unit 43 performs processing for inputting, to the generative AI, the prompt “Please, analyze the market of the domestic railway industry”. Then, the result generation unit 43 acquires, as a market analysis result, the sentence “The railway industry in Japan includes two main sectors of A railway and B railway. The recent trend and a market analysis result are as follows.” generated using the generative AI. Note that the result generation unit 43 may generate and acquire advice for the user based on the result as necessary.

The template recording unit 44 records, in the template DB 31, a template including a plurality of parameters included in a prompt. In other words, the parameters edited highly flexibly by the user him/herself and the prompt including the parameters are recorded as a template in the template DB 31. Thus, using such a template, the server 1 can generate a prompt or perform processing for generating a result, easily. Note that, only in a case where the user makes a request, the template recording unit 44 may record the template.

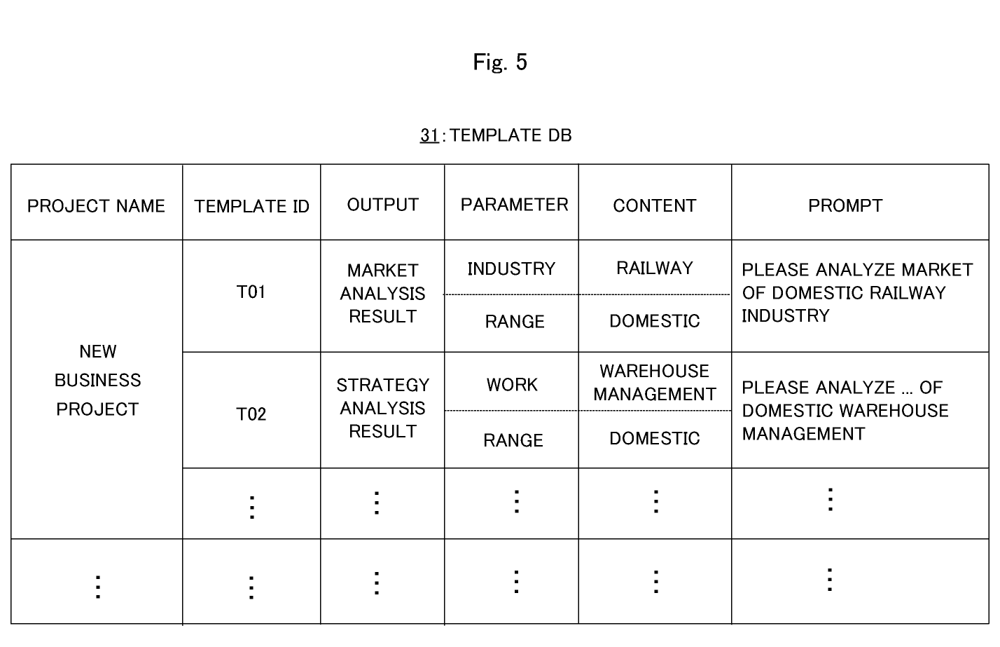

FIG. 5 illustrates an exemplary data configuration of the template DB 31 used in the project support tool. As illustrated in FIG. 5, the template DB 31 includes a project name, a template ID for identifying a template, an output to be output as a result, a parameter, a content input as the parameter, and a prompt for use in processing for generating a result. For example, for the input information input in the input area 55 illustrated in FIG. 4B, as illustrated in FIG. 5, the project name “new business project”, the template ID “T01”, the output “market analysis result”, the parameter “industry” and “range”, the content “railway” and “domestic”, and the prompt “Please analyze the market of the domestic railway industry” are recorded in association as a template. Note that the template recording unit 44 may include a user ID for identifying the user having requested a result and a data source into a template for recording. The prompt generation unit 42 may generate a prompt using a template with reference to the template DB 31.

The process recording unit 45 records, in the process recording DB 32, process information used in a process of generating a result. Note that the process recording unit 45 may record the user ID for the user having requested a result, in association with the generated result.

The display control unit 46 performs control in such a way that a result, advice, and basis information indicating a basis for the result based on the process information are simultaneously displayed on the project support screen. For example, as illustrated in the result display area 57 of FIG. 4B, the display control unit 46 displays the market analysis result “The railway industry in Japan includes two main sectors of A railway and B railway. The recent trend and a market analysis result are as follows.”, the advice “It is recommended to add competitive analysis.”, and the prompt “Please analyze the market of the domestic railway industry” and a link to the data source as a basis for the result, simultaneously. Note that the prompt and the data source as a basis for the result are collectively referred to as “basis information”.

The basis editing unit 47 receives editing on the basis information from the user. For example, in the result display area 57 illustrated in FIG. 4B, the user clicks a pencil mark through a predetermined operation to edit the prompt or the data source. In a case where the user is dissatisfied with the result, the user can rewrite the prompt or make a change or addition to the data source on the project support screen through a predetermined operation, easily. The prompt can be edited individually for each parameter included in the prompt. Note that the template recording unit 44 may record, in the template DB 31, a template including the prompt after editing.

The template editing unit 48 extracts a template recorded in the template DB 31 and edits the template. Note that the prompt generation unit 42 may generate a prompt using the template edited by the user.

The reprocessing unit 49 performs processing for generating a result, again, based on the input information and the edited basis information. Specifically, when the user edits the prompt or the data source and then presses a regeneration button in the result display area 57 illustrated in FIG. 4B, the reprocessing unit 49 generates a result, again, based on the input information and the edited basis information. The user can repeat editing on the basis information and regeneration of a result many times and thus can acquire a satisfied result. In a case where the user acquires a satisfied result, the user terminal 2 may notify the server 1 of approval information on the result through a predetermined operation. The result that is generated by the reprocessing unit 49 and is finally approved by the user as above is also referred to as a “final result”.

The difference analysis unit 50 analyzes the difference between the initial result as the first result generated by the result generation unit 43 and the final result that is generated by the reprocessing unit 49 and is finally approved by the user. An analysis result of the difference may be displayed on the project support screen by the display control unit 46 or may be included in a template and then be recorded in the template DB 31. Specifically, for the analysis result of the difference, for example, the distinction between the initial result and the final result or a part to which an addition is made due to addition of a data source in the final result can be freely set.

Using the analysis result of the difference, the learning unit 51 improves the basis information for use in processing for generating a result. Using the analysis result of the difference for each user, the learning unit 51 may improve the basis information for each user. Specifically, examples of an improvement that the learning unit 51 makes using the analysis result of the difference include selection of a data source at the time of generation of a result similar in input information and setting of a prompt similar in expression to the prompt edited by the user in the past.

According to a conventional tool using generative AI, basis information, such as a prompt and a data source, is typically hidden and thus is not allowed to be edited. In the result generation system 100 according to the present disclosure, the basis information is visualized as an assistance process and the user can freely edit the basis information if the basis information is different from the user’s expectation. A template including the basis information after editing can be recorded in the template DB 31 for practical use.

Note that, in the above-described configuration, the input information acquisition unit 41, the prompt generation unit 42, the result generation unit 43, the template recording unit 44, the process recording unit 45, the display control unit 46, the basis editing unit 47, the template editing unit 48, the reprocessing unit 49, the difference analysis unit 50, and the learning unit 51 in the server 1 are, respectively, an exemplary input information acquisition means, an exemplary prompt generation means, an exemplary result generation means, an exemplary template recording means, an exemplary process recording means, an exemplary display control means, an exemplary basis editing means, an exemplary template editing means, an exemplary reprocessing means, an exemplary difference analysis means, and an exemplary learning means according to the present disclosure. In addition, the basis editing unit 47 is an exemplary prompt editing means according to the present disclosure.

### Result Generation Processing

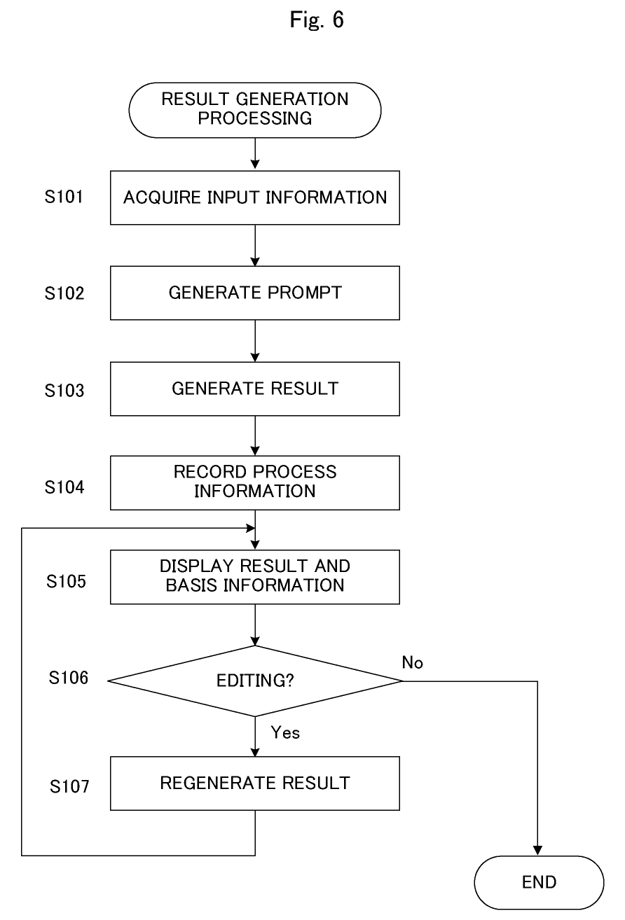

Next, result generation processing that the server 1 performs will be described. FIG. 6 is a flowchart illustrating exemplary result generation processing that the server 1 performs. The processor 12 illustrated in FIG. 2 executes a program prepared in advance to achieve the processing.

First, the server 1 acquires input information from the user terminal 2 (step S101). Next, the server 1 generates a prompt for use in processing for generating a result using the generative AI, based on the input information (step S102). The server 1 performs processing for inputting the prompt to the generative AI to generate a result (step S103). The server 1 records, in the process recording DB 32, process information used in a process of generating a result (step S104).

Next, the server 1 transmits the generated result and basis information based on the process information to the user terminal 2 to display the generated result and the basis information (step S105). Specifically, the server 1 causes the user terminal 2 to display, as the basis information, a data source and reference information used at the time of generating a result and the prompt used in the processing for generating a result. The server 1 determines whether the user has edited the basis information (step S106). When determining that editing has been performed (step S106; Yes), the server 1 performs processing for generating a result, again, based on the input information and the edited basis information (step S107) and the processing goes back to step S105. On the other hand, when determining that no editing has been performed (step S106; No), the server 1 terminates the result generation processing.

According to the result generation system 100 as above, basis information indicating a basis for a result is presented to the user to visualize an internal process and a generative rule, so that transparent feedback can be achieved to the user. Thus, problems can be solved, such as impaired reliability due to insufficient description of a result and the difficulty that a user has in understanding because the determination process of an AI tool is opaque. Thus, the user can clearly understand the determination process of an AI tool, leading to an improvement in reliability and a reduction in the barrier to entry. Therefore, operational optimization is promoted, so that an improvement in efficiency can be achieved.

The result generation system 100 enables recording or inspection of the operation process of AI required from the viewpoint of regulation and compliance. Therefore, the functions of compliance checking and traceability can be enhanced, enabling management meeting industry regulations and compliance standards.

According to the result generation system 100, the basis information can be used as a template or the basis information can be edited in such a way as to be used in reprocessing. In other words, the result generation system 100 provides an interface that allows the user to edit or verify a process of generating a result, enabling the user to intuitively understand the influence of a result. As above, due to presentation of the logic of AI and a rule of thumb to the user, the user can understand the operation principle of AI and use the tool with a sense of satisfaction. Thus, even an inexperienced user can use the tool with satisfaction while understanding the operation principle and logic of AI and thus an AI-tool educational effect can be expected.

### Second Example Embodiment

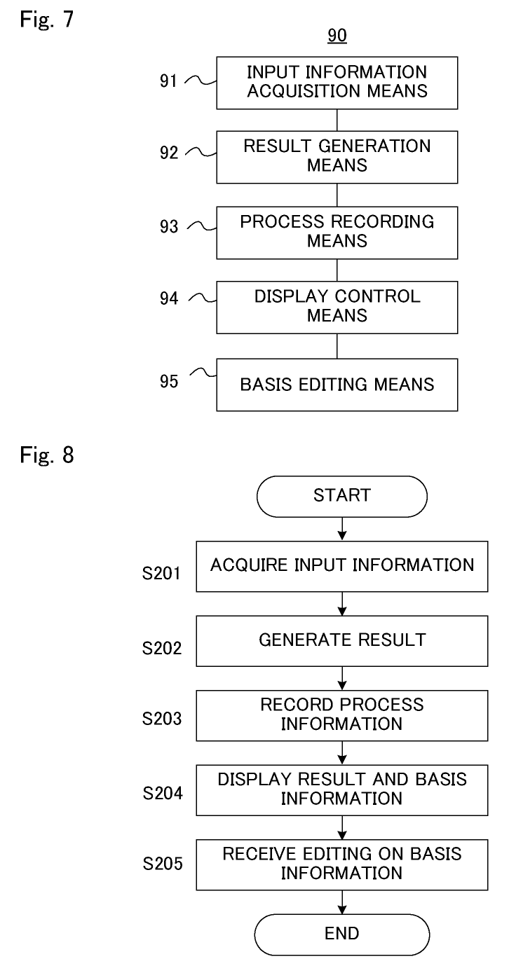

FIG. 7 is a block diagram illustrating an exemplary functional configuration of an information processing device according to the present disclosure. An information processing device 90 includes an input information acquisition means 91, a result generation means 92, a process recording means 93, a display control means 94, and a basis editing means 95.

FIG. 8 is a flowchart illustrating exemplary processing that the information processing device 90 performs. The input information acquisition means 91 acquires input information from a user (step S201). The result generation means 92 performs processing based on the input information to generate a result (step S202). The process recording means 93 records process information used in a process of generating the result (step S203). The display control means 94 displays the result and basis information indicating a basis for the result based on the process information, simultaneously (step S204). The basis editing means 95 receives editing on the basis information from the user (step S205). The information processing device 90 visualizes a process in which a result is generated using generative AI and a basis for the result, leading to improvements in the transparency and reliability of operation of the generative AI.

A part or all of the example embodiments described above may also be described as the following Supplementary Notes, but not limited thereto.

### Supplementary Note 1

An information processing device comprising:

an input information acquisition means configured to acquire input information from a user;

a result generation means configured to perform processing based on the input information to generate a result;

a process recording means configured to record process information used in a process of generating the result;

a display control means configured to display the result and basis information indicating a basis for the result based on the process information, simultaneously; and

a basis editing means configured to receive editing on the basis information from the user.

### Supplementary Note 2

The information processing device according to Supplementary Note 1, wherein the basis information includes a prompt for use in the processing for generating the result.

### Supplementary Note 3

The information processing device according to Supplementary Note 2, wherein

the basis editing means includes a prompt editing means configured to receive editing on the prompt from the user,

the prompt includes a plurality of parameters, and

the prompt editing means allows the parameters to be individually edited.

### Supplementary Note 4

The information processing device according to Supplementary Note 3, further comprising:

a template recording means configured to record a template including the plurality of parameters included in the prompt;

a template editing means configured to receive editing on the template from the user; and

a prompt generation means configured to generate the prompt using the template subjected to the editing by the user.

### Supplementary Note 5

The information processing device according to Supplementary Note 3, further comprising a reprocessing means configured to perform processing for generating a result, again, based on the input information and the basis information subjected to the editing.

### Supplementary Note 6

The information processing device according to Supplementary Note 5, wherein the process information includes at least one of the prompt, a data source, reference information, and information regarding the result generated again by the reprocessing means.

### Supplementary Note 7

The information processing device according to Supplementary Note 6, further comprising a difference analysis means configured to analyze a difference between an initial result as a first result generated by the result generation means and a final result that is generated by the reprocessing means and is finally approved by the user.

### Supplementary Note 8

The information processing device according to Supplementary Note 7, further comprising a learning means configured to improve the basis information for use in processing for generating a result, using an analysis result of the difference.

### Supplementary Note 9

An information processing method to be performed by an information processing device, the information processing method comprising:

acquiring input information from a user;

performing processing based on the input information to generate a result;

recording process information used in a process of generating the result;

displaying the result and basis information indicating a basis for the result based on the process information, simultaneously; and

receiving editing on the basis information from the user.

### Supplementary Note 10

A program to be executed by an information processing device including a computer, the program causing the computer to perform processing comprising:

acquiring input information from a user;

performing processing based on the input information to generate a result;

recording process information used in a process of generating the result;

displaying the result and basis information indicating a basis for the result based on the process information, simultaneously; and

receiving editing on the basis information from the user.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Furthermore, some or all of the configurations described as Supplementary Notes can be similarly dependent on not only Supplementary Notes 1, 9, and 10, but also various pieces of hardware and software, and various recording means or systems for recording software without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

1 Server

2 User terminal

11, 21 Interface

12, 22 Processor

13, 23 Memory

14, 24 Recording medium

15, 25 Display unit

16, 26 Input unit

31 Template DB

32 Process recording DB

41 Input information acquisition unit

42 Prompt generation unit

43 Result generation unit

44 Template recording unit

45 Process recording unit

46 Display control unit

47 Basis editing unit

48 Template editing unit

49 Reprocessing unit

50 Difference analysis unit

51 Learning unit

100 Result generation system

1. An information processing device comprising:
at least one memory configured to store instructions; and
at least one processor configured to execute the instructions to:
acquire input information from a user;
perform processing based on the input information to generate a result;
record process information used in a process of generating the result;
display the result and basis information indicating a basis for the result based on the process information, simultaneously; and
receive editing on the basis information from the user.

2. The information processing device according to claim 1, wherein the basis information includes a prompt for use in the processing for generating the result.

3. The information processing device according to claim 2, wherein
the processor receives editing on the prompt from the user, in receiving the editing on the basis information from the user
the prompt includes a plurality of parameters, and
the processor allows the parameters to be individually edited.

4. The information processing device according to claim 3, wherein the processor is further configured to:
record a template including the plurality of parameters included in the prompt;
receive editing on the template from the user; and
generate the prompt using the template subjected to the editing by the user.

5. The information processing device according to claim 3, wherein the processor is further configured to perform processing for generating a result, again, based on the input information and the basis information subjected to the editing.

6. The information processing device according to claim 5, wherein the process information includes at least one of the prompt, a data source, reference information, and information regarding the result generated again by the processing for generating the result, again.

7. The information processing device according to claim 6, wherein the processor is further configured to analyze a difference between an initial result as a first result generated by performing the processing and a final result that is generated by the processing for generating the result, again and is finally approved by the user.

8. The information processing device according to claim 7, wherein the processor is further configured to improve the basis information for use in processing for generating a result, using an analysis result of the difference.

9. An information processing method to be performed by an information processing device, the information processing method comprising:
acquiring input information from a user;
performing processing based on the input information to generate a result;
recording process information used in a process of generating the result;
displaying the result and basis information indicating a basis for the result based on the process information, simultaneously; and
receiving editing on the basis information from the user.

10. A non-transitory computer-readable recording medium storing a program to be executed by an information processing device including a computer, the program causing the computer to perform processing comprising:
acquiring input information from a user;
performing processing based on the input information to generate a result;
recording process information used in a process of generating the result;
displaying the result and basis information indicating a basis for the result based on the process information, simultaneously; and
receiving editing on the basis information from the user.
